(19) United States
(12) Patent Application Publication
(10) Pub. No.: US 2014/0053069 A1
(43) Pub. Date: Feb. 20, 2014

(54) IDENTIFYING AND MITIGATING RISKS IN CONTRACT DOCUMENT USING TEXT ANALYSIS WITH CUSTOM HIGH RISK CLAUSE DICTIONARY

(71) Applicant: Nancy Yan, Cupertino, CA (US)

(72) Inventor: Nancy Yan, Cupertino, CA (US)

(73) Assignee: SAP AG, Walldorf (DE)

(21) Appl. No.: 13/587,761

(22) Filed: Aug. 16, 2012

(51) Int. Cl. G06F 17/21

(52) U.S. Cl. 715/259

(57) ABSTRACT

Approaches to identifying and evaluating risks in a contract document include a method implemented at least in part by one or more computing devices for analyzing a contract document to identify risks. The method includes analyzing text of a contract document, comparing the text of the contract document to a clause dictionary and identifying at least one clause of the contract document to a user based on its risk level. A contract document analysis system can include a user interface configured to display a contract document, a clause dictionary stored in memory and a text processing engine. The clause dictionary comprises predetermined clauses of interest to users. The analysis engine receives at least a portion of the contract document and performs test analysis to determine whether the contract document contains any clauses that resemble the predetermined clauses in the clause dictionary. For qualifying clauses, suggestions for action are displayed.

### BACKGROUND

In large organizations, considerable time is spent in preparing and administering agreements or contracts with other entities and individuals. Such contracts can be lengthy and complex documents, as the parties to the agreement attempt to cover all possible scenarios to mitigate risks and avoid surprises. During the drafting phase, and also during performance of the contract, it is often useful to evaluate the contract according to one or more criteria, including relative to other contracts to which the organization is a party. For example, it is often helpful to assign a relative risk level to an entire contract or a portion of a contract, and to use this risk level in making decisions. If many contracts are involved, however, the tasks of analyzing, recording and tracking them are cumbersome and prone to error.

Also, to the extent that information from prior contracts is to be useful to guide the drafting of a current contract, then such information needs to be available in real-time. In many cases, knowledge and/or authority over the many areas affected by a contract are spread widely among many individuals and/or departments within an organization. These individuals and departments must have access to up-to-date information if their participation in the contract drafting process is to be as beneficial as possible.

### SUMMARY

This Summary is provided to introduce a selection of concepts in simplified form that are further described below in the Detailed Description.

This Summary is not intended to identify key features or essential features of the claimed subject matter, nor is it intended to be used to limit the scope of the claimed subject matter.

Described below are approaches to identifying and evaluating risks in a contract document. According to one implementation, a method is implemented at least in part by one or more computing devices for analyzing a contract document to identify risks. The method includes analyzing text of a contract document, comparing the text of the contract document to a clause dictionary, and identifying at least one clause of the contract document to a user based on its risk level.

As another example, a contract document analysis system can include a user interface configured to display a contract document, a clause dictionary stored in memory and an text analysis engine. The clause dictionary comprises predetermined clauses, expressions and rules of interest to users. The analysis engine receives at least a portion of the contract document and performs text analysis to determine whether the contract document contains any qualifying clauses that resemble the predetermined clauses in the clause dictionary. For qualifying clauses, suggestions for action are displayed to the user.

The foregoing and other objects, features, and advantages of the invention will become more apparent from the following Detailed Description, which proceeds with reference to the accompanying figures.

### BRIEF DESCRIPTION OF THE DRAWINGS

FIG. 1 is an illustration of an exemplary user interface for identifying and evaluating clauses in a contract document.

FIG. 2 is a further illustration of the user interface of FIG. 1.

FIG. 3 is an illustration of a spreadsheet by which predefined clauses and expressions are added to a clause dictionary.

FIG. 4 is a flowchart of a method implementation for identifying and evaluating clauses of a contract.

FIG. 5 is a flow chart of an alternative method implementation.

FIG. 6 is an illustration of a quadrant graph that can be presented to users to assist in evaluating various parameters, such as priority, risk and contract value.

FIG. 7 is a block diagram of an exemplary computing environment with a text analysis engine.

FIG. 8 is a block diagram of an exemplary computing environment with a collaboration application.

FIG. 9 is a diagram of an exemplary computing system in which some described embodiments can be implemented.

FIG. 10 is an exemplary cloud computing environment that can be used in conjunction with the technologies described herein.

### DETAILED DESCRIPTION

According to the described approaches, a document can be analyzed for desired parameters to inform a user viewing the document, e.g., to make changes to the document, if necessary. In some examples, the document is a contract document, and at least one user is a contract administrator overseeing the process of preparing the contract. The contract is complex and has many clauses, which are defined herein as parts of the contract less than the whole contract. Other than the user, many others within the user's organization have knowledge and expertise about specific clauses of the contract.

As the user oversees the contract process and clauses are drafted and/or modified, either internally or through negotiation with other parties to the contract, the system assists the user in maintaining control over the content of the contract. The organization may have “hardline” rules against certain types of clauses. As another example, the organization may seek to handle a specific type of clause that is routinely encountered using the organization's specific wording. As still another example, the user may seek to streamline approval for particular clauses on the basis that they conform to wording previously approved by certain individuals and/or departments of the organization.

In the systems and methods described below, a current document is analyzed and compared to a clause dictionary to determine clauses of interest. The clause dictionary contains clauses that the user has entered, based on the importance to the organization, based on past contracts, based on analytics, or other factors. In this way, the current contract document can be flagged where it contains a clause that resembles a clause in the clause dictionary. Such resembling clauses can be clauses that exactly match the clauses stored in the clause dictionary, or clauses that are close variants thereof and thus have the same expression pattern.

One category of interest to organizations is risk, and in particular, financial risk. Thus, in monitoring and tracking its level of risk, the organization needs to know what risks it is undertaking by way of the contracts into which it enters.

For example, the user in her contract administrator role may know that her company carries a general liability insurance policy limited to $2,000,000. Therefore, the contract administrator sets up the clause dictionary so that any contract requiring her organization to have more than $2,000,000 in general liability insurance is flagged for review and re-negotiation. At the same time, clauses with suggested alternative wording (e.g., a lower general liability insurance limit), such as from prior contracts to which the organization is a party, can be displayed. If desired, these alternative clauses can include links to the underlying documents in which the alternative clauses appeared, which allows any viewing user to see the alternative clauses in their original contexts. If appropriate, the alternative clause can be chosen and the current contract document is automatically updated with the current clause. Such a system allows users to monitor contracts in various ways, including (1) tracking risk posed by any single type of clause, (2) tracking risk posed by an entire contract and/or (3) tracking risk posed by the aggregate of multiple contracts.

As one example of use, the user in her contract administrator role has others within the organization review clauses over which they have expertise. Changes to the clauses are implemented, perhaps by other users who have expertise over the areas to which the specific clauses pertain, but lack awareness of the entire contract or the organization's past handling of a similar clause. Thus, the approaches described herein allow at least the contract administrator, to ensure that changes to the contract conform with the decisions that led to the content of the clause dictionary.

In addition, a user interface that presents the above information can also present users with metrics. For example, on the issue of risk, a quadrant graph or other graphic can be presented to show users the relative risk posed by the clause or contract in question so that the users can make good decisions about much time and resources should be spent in addressing issues raised by the clause.

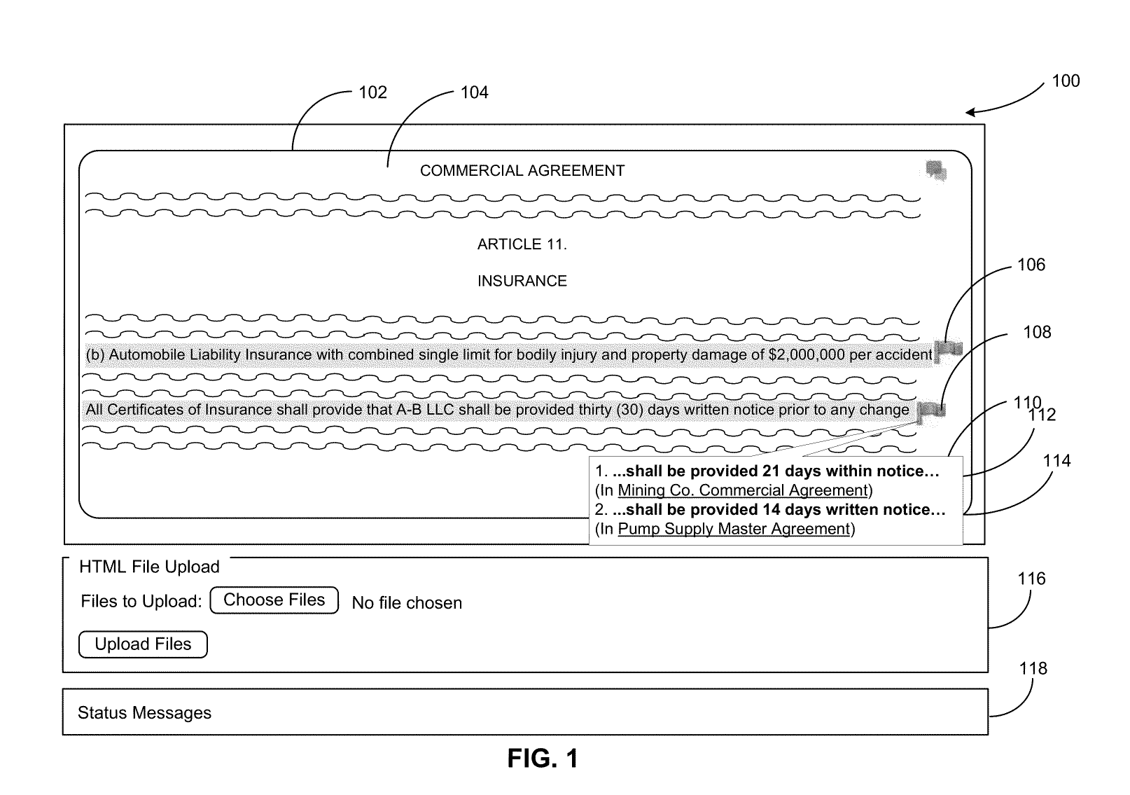

FIG. 1 is an illustration of an exemplary user interface for presenting a contract document. In FIG. 1, there is a document container 102 within which a current contract document 104 is displayed to the user. There is a first clause flag 106 marking a first highlighted clause (“(b) Automobile Liability Insurance with combined single limit for bodily injury and property damage of $2 million per accident;”). There is a second clause flag 108 for the second highlighted clause (“All Certificates of Insurance shall provide that A-B LLC shall be provided thirty (30) days written notice prior to any change . . . ”). For the second clause, there is a suggested alternative clauses pop-up 110 in which a first alternative clause 112 and a second alternative clause 114 are displayed. As shown for the first alternative clause 112, there is a related document (the “Mining Co. Commercial Agreement”) in which the period for written notice is 21 days instead of 30 days as in the second highlighted clause. Similarly, the second alternative clause 114, which is from a “Pump Supply Master Agreement,” specifies a period of 14 days written notice instead of 30 days. In this example, the period for returning Certificates of Insurance has been recognized as a potential risk, and the clause dictionary has been updated to include clauses relating to this time period so that analysis of contract documents will cause the same and similar clauses to be flagged. After analysis of the current contract document 104, the wording of the second clause triggers display of the alternative clauses 112, 114. In response to the displayed clauses, the user can choose either of the alternative clauses (such as by selecting the alternative clause and clicking the right mouse button), or ignore both alternative clauses and keep the current second highlighted clause, or create a new alternative clauses for use. It should be noted that at the specific stage in the process shown in FIG. 1, any alternative clauses for the first highlighted clause have already been displayed and selected or ignored, and the process has proceeded to the second highlighted clause.

Below the document container 102, there is a file upload panel to allow the user to choose files to be uploaded into the document container and to display the names of files that have been uploaded. There is also a status messages field 118 within which messages about the status of the contract document and system can be displayed. In the case of two files uploaded at the same time, two documents are opened in the document container side by side. This arrangement can be used for document comparison or cross-referencing, or to permit easy dragging of clauses from one document for dropping into the other document.

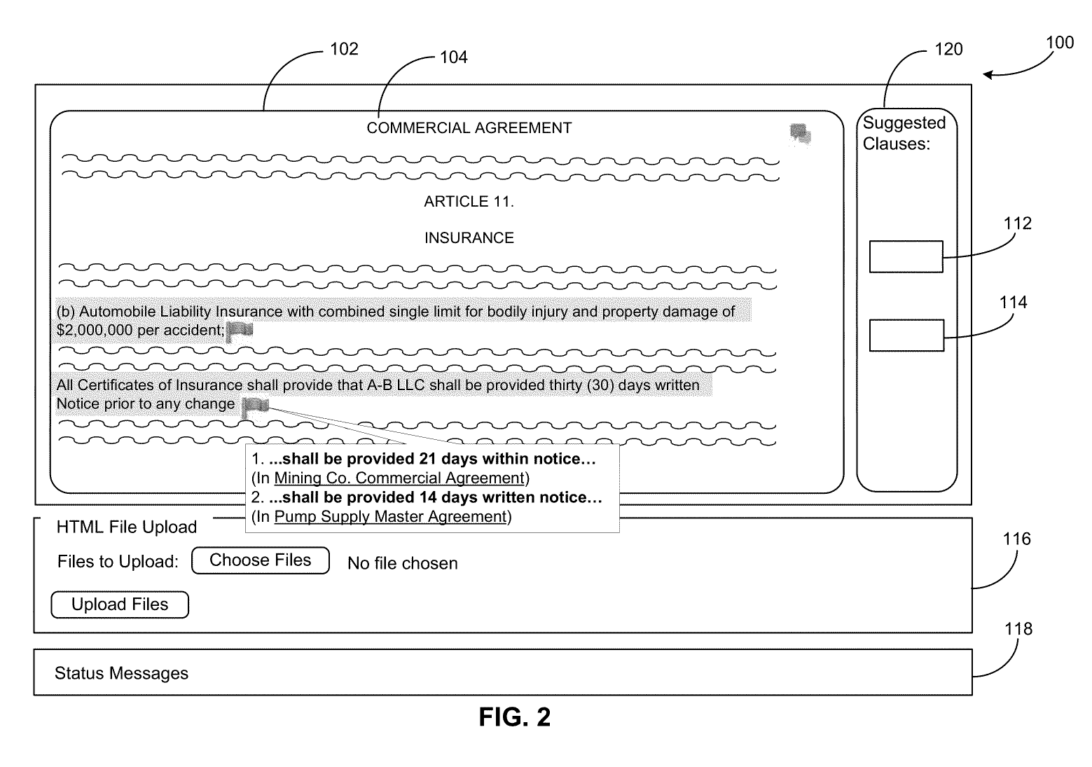

FIG. 2 is similar to FIG. 1, except that the first alternative clause 112 and the second alternative clause 114 are shown in a separate suggested clauses panel 120 displayed to the side of the document container 102. In the illustrated implementation, the panel 120 is arranged to be right of the document container 102, but other locations are of course possible.

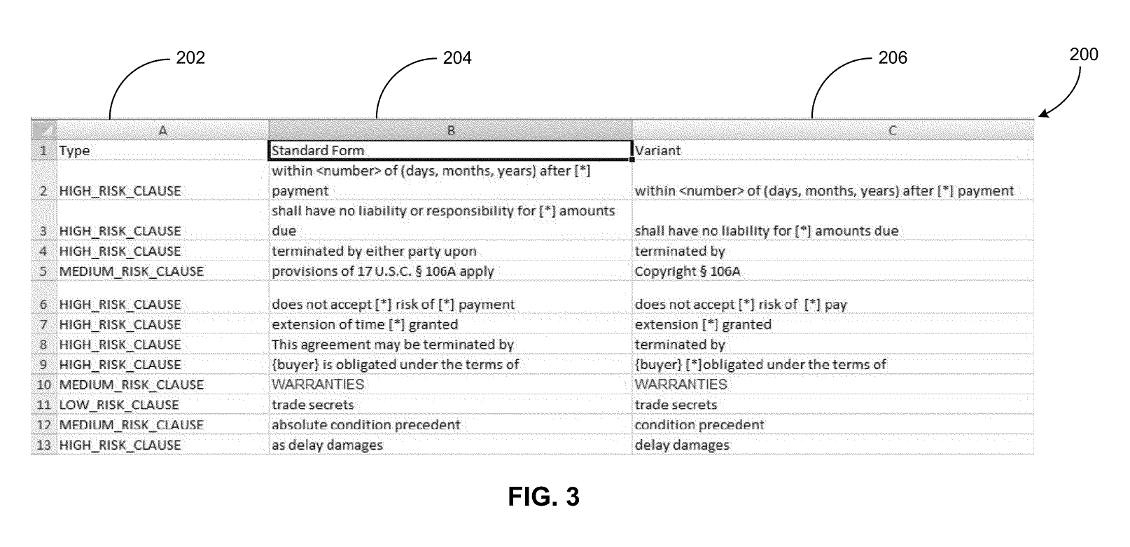

FIG. 3 is a representation of data to be added to the clause dictionary. The data can be presented in many different forms, such as a spreadsheet 200 as shown in FIG. 3. In FIG. 3, there is a clause type identifier column 202 in which the clauses of interest are distinguished into categories. For example, in the scenario of analyzing documents for clauses according to risk, the types of clauses indicated in column 202 include high risk, medium risk and low risk clauses. It would of course be possible to include fewer or greater categories of risk, or to use a distinguishing categorization other than risk. There is a standard clause form column 204 in which the standard form of clauses of interest is listed. As indicated, any text of interest within a contract document can be searched, and operators can be included, such as wildcard and other operators, such that meaningful results are obtained. For example, the “asterisk” character can be programmed to serve as a special placeholder such that characters between two instances of “[*]” are ignored during the searching. There is a variant clause forth column 206 within which variants of the clauses in the standard clause form column 204 can be specified. In this way, the searching can be made more robust so that clauses having the same or similar effect, and thus the same risk, are found and characterized together.

The content of the clause dictionary can be modified in several different ways. For example, users can update the clause dictionary to include clauses of particular interest to their organizations. In addition, it would be possible to have the system automatically update the clause dictionary with clauses that meet certain criteria, e.g., currency amounts that exceed a predetermined threshold. In addition, various analytic routines could be run on a set of contract documents to determine clauses of interest based on various statistical and analytical methods. As just some examples, the most modified clauses, the most negotiated clauses, and/or the clauses requiring the highest level of sign-off authority can be added to the clause dictionary automatically.

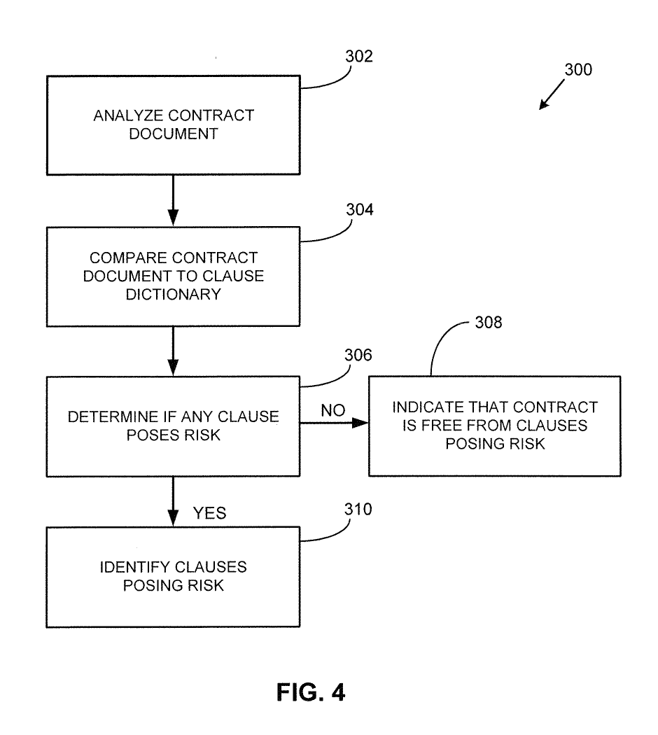

FIG. 4 is a flowchart of a method implementation for identifying and evaluating clauses of interest in a contract document. In the method 300, the contract document is analyzed (step 302), such as with a text analysis engine as is described in more detail below. In step 304, the current contract document is compared with a clause dictionary. In step 306, it is determined whether any of the clauses in the current contract document sufficiently resemble any of the clauses in the clause dictionary (where “resemble” is defined to mean exactly match, to be a close variant thereof or to have the same expression pattern). In the example of FIG. 4, the specific determination of whether a current contract document clause resembles a clause in the clause dictionary is completed to determine if the current contract clause poses sufficient risk. If no clauses in the current contract document sufficiently resemble the clauses of the clause dictionary, then it is indicated that the contract document is free from clauses posing risk (step 308). If there is at least one clause of the current contract document that sufficiently resembles a clause of the clause dictionary, then that clause is identified as posing risk (step 310). Risks at clause level are rolled up into the contract document. If quite a few clauses match a high risk clause pattern in the dictionary, then the contract document is rated high risk.

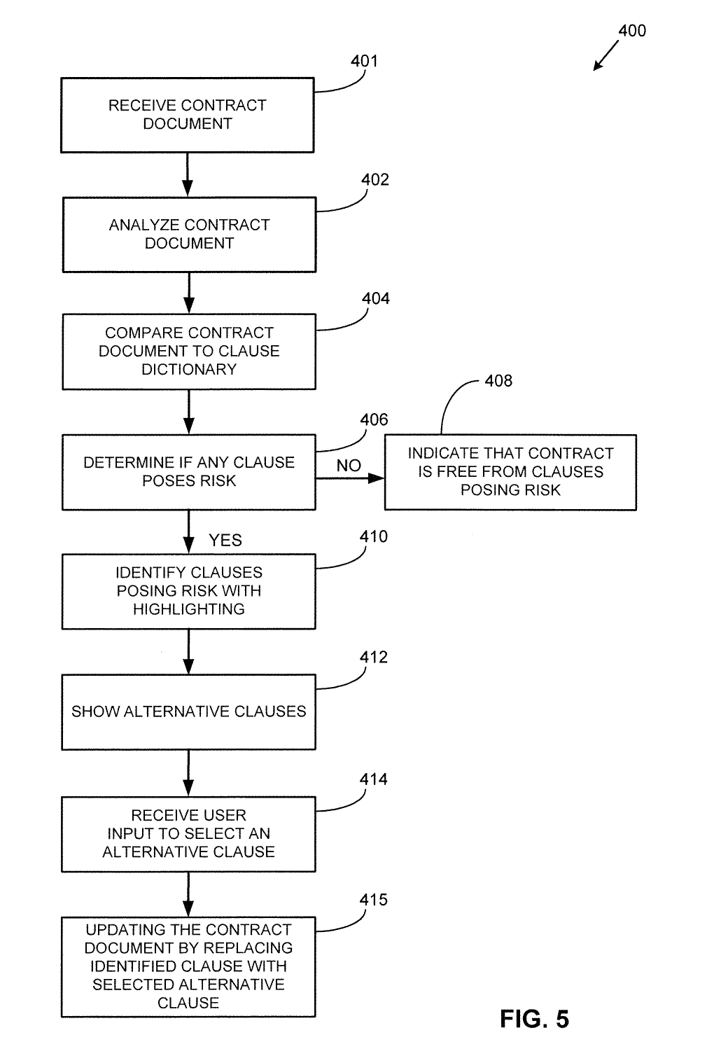

FIG. 5 is a flowchart of another method implementation for identifying and evaluating clauses of interest in a contract documents. In the method 400, there is a preliminary step 401 in which a contract document is received. Typically, contract documents are simply uploaded to the system in any conventional format, such as Microsoft Word or Adobe PDF, as just two examples. If, after analysis and comparison (steps 402 and 404), it is determined in step 406 that there is at least one clause in the current contract document that poses risk, then that clause is identified to the user by highlighting the clause in the displayed contract document in step 410. In step 412, any available alternative clauses are displayed to the user, either in a popup window, a separate panel or in another suitable format. In step 414, the system receives any user input made to select any of the displayed alternative clauses. In step 415, the current contract document is updated by replacing the identified clause with any selected alternative clause. If not clause poses risk, then an indicating of this result is displayed to the user (step 408).

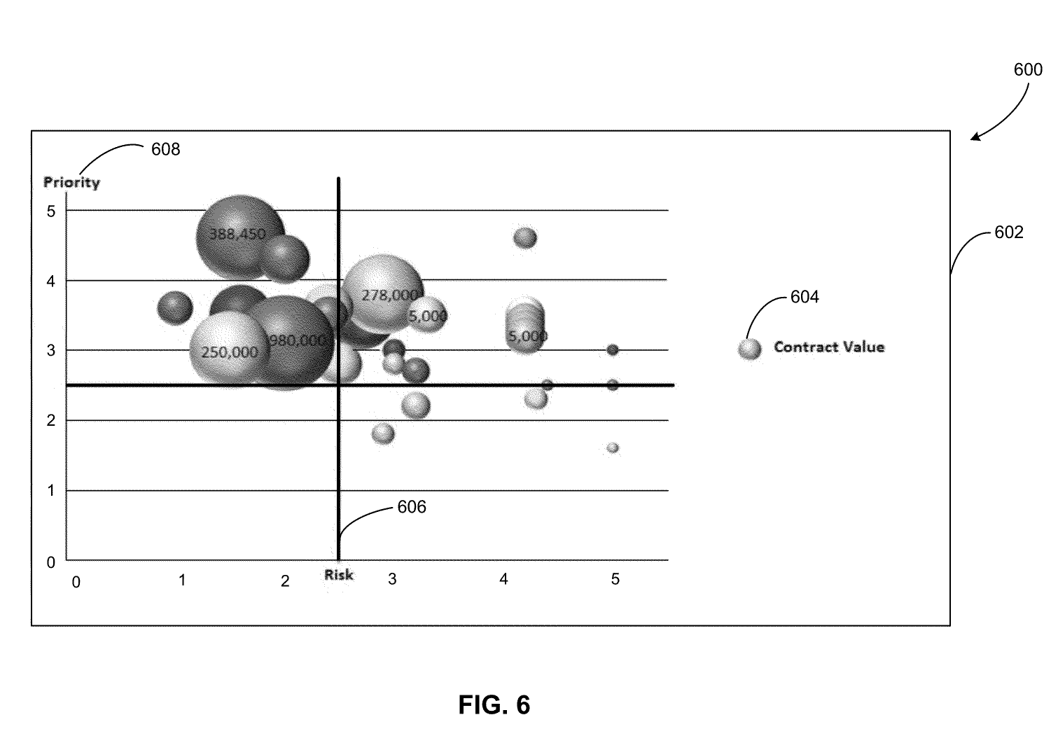

FIG. 6 is an illustration of a metric that can be displayed to the user via the user interface. In FIG. 6, the metric 600 is a quadrant graph 602. In the quadrant graph 602, the contract value is dollars as shown by the size of the data point, and the data points are plotted on the axes of risk 606 and priority 608. Such a risk assessment report helps contract managers prioritize work in the contract pipeline by assisting with visualization of the size of the contract, risk levels and priorities. Among the key performance indicators (KPIs) such as contract value, priority and risk, the indicator of risk for each contract document is an aggregation result of clause risks.

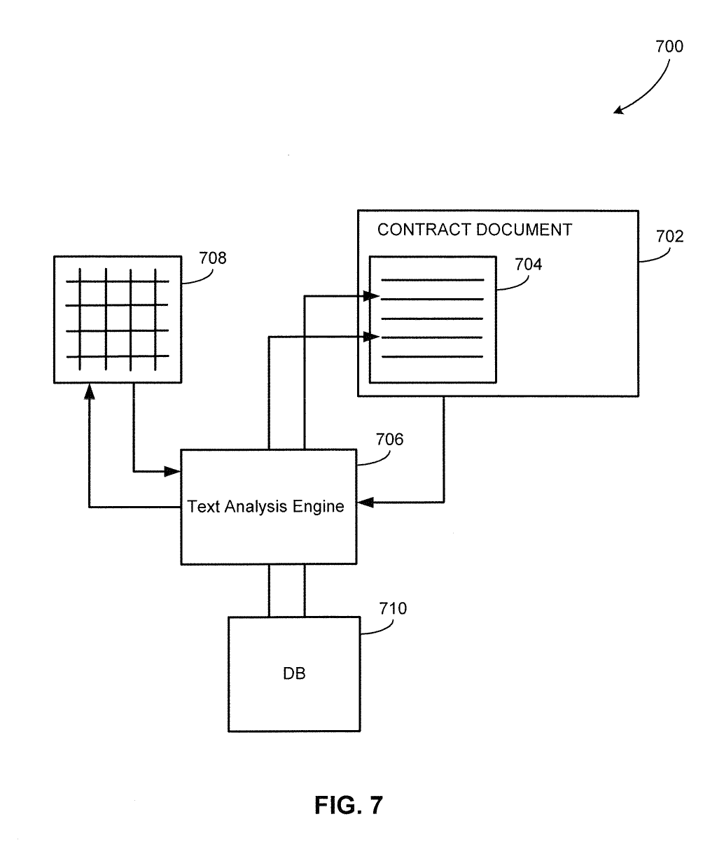

FIG. 7 is a block diagram showing major components of the system 700. Via a user interface 702, a user can request that a contract document 704 be displayed. In some implementations, this automatically causes a text analysis web service to use a text analysis engine 706 to analyze the current contract document 704 relative to a dictionary 708 of clauses of interest. In other implementations, the user clicks on a “Analyze Risks” button to trigger such analysis. The text analysis engine 706 can be linked to a database 710 by which rules and expressions used in text analysis can be updated. The contract documents are stored in a database, such as the same database 710 or in a different database. In some embodiments, the contract documents are stored in multiple versions, such as the original version and each updated version.

After analysis is completed, clauses meeting analysis criteria can be highlighted in the contract document such that they are visible to the user, as described above and shown in, e.g., FIG. 1. In addition, suggested alternative clauses can be shown on the user interface 702. In some implementations, clauses are highlighted in different colors, such as to indicate high, medium and low risk, as some examples.

A measure of the overall risk of the contract document can be displayed to the user via the user interface. The system can aggregate an average of the total high, medium and low risk clauses in the document, and assign an overall risk rating relative to other contract documents.

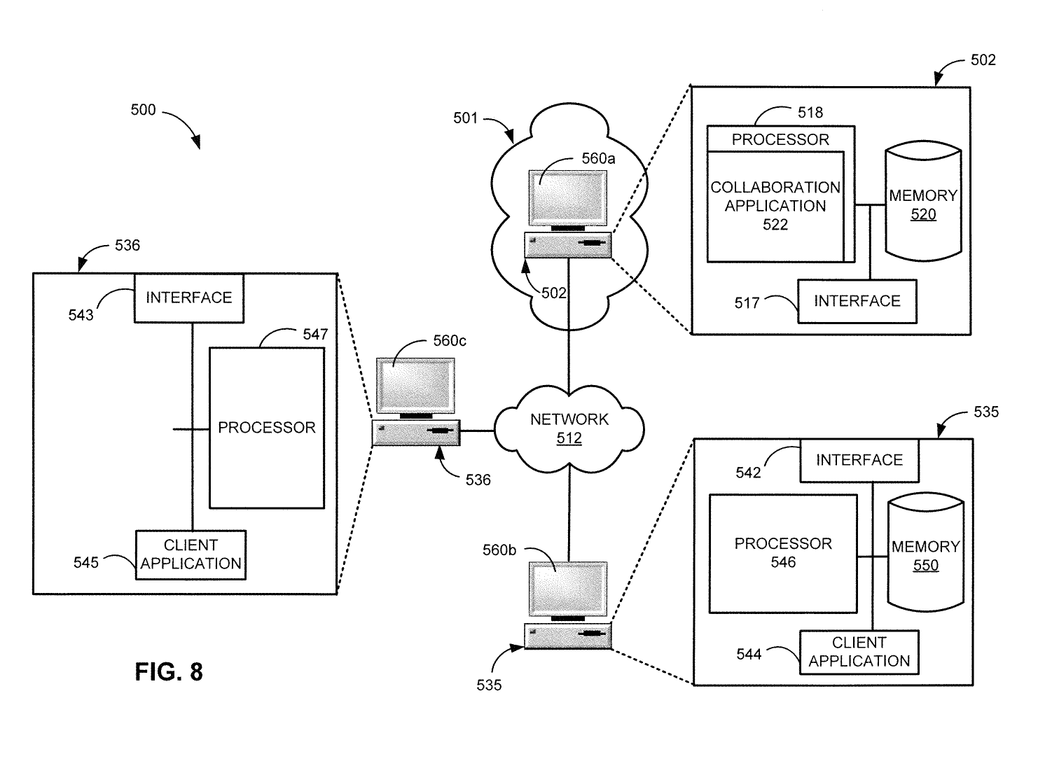

FIG. 8 illustrates an optional environment 500 for collaboratively working on activities, including the administration of contract documents, and implementing one or more business process(es) of at least one business process model based on the entries. The illustrated environment 500 includes or is communicably coupled with server 502 and one or more clients 535 and 536, at least some of which communicate across network 512. In general, environment 500 depicts an example configuration of a system capable of providing access to online collaboration tools. The environment 500 also supports one or more servers operable to provide a set of services to the client 535 or server 502 in which the one or more servers can be logically grouped and accessible within a cloud computing network. For example, server 502 is a cloud-based server, persisting in cloud 501. Accordingly, the collaboration interface may be provided to a client 535 or server 502 as an on-demand solution through the cloud computing network or as a traditional server-client system. Further, the environment 500 also supports a BPMS system operated by one or more web application servers. Different components of the BPMS system may be used to in a collaboration based on participant entries or requests.

In general, server 502 is any server that stores one or more hosted applications, such as collaboration application 522, where at least a portion of the hosted applications are executed via requests and responses sent to users (also referred to as participants) or clients within and communicably coupled to the illustrated environment 500 of FIG. 8. As just some examples, server 502 may be a Java 2 Platform, Enterprise Edition (J2EE)-compliant application server that includes Java technologies such as Enterprise JavaBeans (EJB), J2EE Connector Architecture (JCA), Java Messaging Service (JMS), Java Naming and Directory Interface (JNDI), and Java Database Connectivity (JDBC). In some instances, the server 502 may store a plurality of various hosted applications, while in other instances, the server 502 may be a dedicated server meant to store and execute only a single hosted application. In FIG. 8, the collaboration application 522 provides a collaboration interface for users to participate in collaborations. In some instances, the server 502 may comprise a web server or be communicably coupled with a web server, where the collaboration applications 522 represent one or more web-based applications accessed and executed via network 512 by the clients 535 and 536 of the system 500 to perform the programmed tasks or operations of the collaboration application 522.

At a high level, the server 502 includes an electronic computing device, such as processor 518, operable to receive, transmit, process, store, or manage data and information associated with the environment 500. The server 502 illustrated in FIG. 8 can be responsible for receiving application requests from one or more client applications 544 or 545 or business applications associated with the clients 535 and 536 of environment 500 and responding to the received requests by processing them in the associated collaboration application 522, and sending the appropriate response from the collaboration application 522 back to the requesting client application 544 or 545. Alternatively, the collaboration application 522 at server 502 can be capable of processing and responding to local requests from a user accessing server 502 locally. Accordingly, in addition to requests from the external clients 535 and 536 illustrated in FIG. 8, requests associated with the collaboration applications 522 may also be sent from internal users, external or third-party customers, other automated applications, as well as any other appropriate entities, individuals, systems, or computers. Further, the terms “client application” and “business application” may be used interchangeably as appropriate without departing from the scope of this disclosure.

As used in the present disclosure, the teen “computer” is intended to encompass any suitable processing unit. For example, although FIG. 8 illustrates a single server 502, environment 500 can be implemented using two or more servers 502, as well as computers other than servers, including a server pool. Indeed, server 502 may be any computer or processing unit such as, for example, a blade server, general-purpose personal computer (PC), Macintosh, workstation, UNIX-based workstation, or any other suitable device. In other words, the present disclosure contemplates computers other than general purpose computers, as well as computers without conventional operating systems. Further, illustrated server 502 may be adapted to execute any operating system, including Linux, UNIX, Windows, Mac OS, or any other suitable operating system. According to one embodiment, server 502 may also include or be communicably coupled with a mail server.

In the illustrated implementation, and as shown in FIG. 8, the server 502 includes a processor 518, an interface 517, a memory 520, and a collaboration application 522. The interface 517 is used by the server 502 for communicating with other systems in a client-server or other distributed environment (including within environment 500) connected to the network 512 (e.g., clients 535 and 536, as well as other systems communicably coupled to the network 512). Although FIG. 8 depicts a server-client environment, other implementations of the runtime framework for providing business processes within a collaboration are within the scope of the present disclosure. For example, the runtime framework may be provided or accessed locally at a computer. Generally, the interface 517 includes logic encoded in software and/or hardware in a suitable combination and operable to communicate with the network 512. More specifically, the interface 517 may include software supporting one or more communication protocols associated with communications such that the network 512 or interface's hardware is operable to communicate physical signals within and outside of the illustrated environment 500.

In some implementations, the server 502 may also include a user interface, such as a graphical user interface (GUI) 560a (560b for client 536 and 560c for client 536). The interfaces described above in connection with FIGS. 1-3 and 6 are examples.

The GUI 560a can comprise a graphical user interface operable to, for example, allow the user of the server 502 to interface with at least a portion of the platform for any suitable purpose, such as, e.g., creating, preparing, requesting, or analyzing data, as well as viewing and accessing source documents. Generally, the GUI 560a provides the particular user with an efficient and user-friendly presentation of data provided by or communicated within the system.

The GUI 560a may comprise a plurality of customizable frames or views having interactive fields, pull-down lists, buttons, and other controls operated by the user. For example, GUI 560a may provide interactive elements that allow a user to enter or select elements of business process instances in GUI 560a. More generally, GUI 560a may also provide general interactive elements that allow a user to access and utilize various services and functions of application 522. The GUI 560a is often configurable, supports a combination of tables and graphs (bar, line, pie, status dials, etc.), and is able to build real-time portals, where tabs are delineated by key characteristics (e.g. site or micro-site). Therefore, the GUI 560a contemplates any suitable graphical user interface, such as a combination of a generic web browser, intelligent engine, and command line interface (CLI) that processes information in the platform and efficiently presents the results to the user visually. Similar reference numerals correspond to similar elements of FIG. 8. For example, GUI 560b and 560c are similar to GUI 560a.

Generally, example server 502 may be communicably coupled with a network 512 that facilitates wireless or wireline communications between the components of the environment 500 (e.g., between the server 502 and client 535), as well as with any other local or remote computer, such as additional clients, servers, or other devices communicably coupled to network 512 but not illustrated in FIG. 8. In the illustrated environment, the network 512 is depicted as a single network in FIG. 8, but may be comprised of more than one network without departing from the scope of this disclosure, so long as at least a portion of the network 512 may facilitate communications between senders and recipients. The network 512 may be all or a portion of an enterprise or secured network, while in another instance at least a portion of the network 512 may represent a connection to the Internet. In some instances, a portion of the network 512 may be a virtual private network (VPN), such as, for example, the connection between the client 535 and the server 502. Further, all or a portion of the network 512 can comprise either a wireline or wireless link. Example wireless links may include 802.11a/b/g/n, 802.20, WiMax, and/or any other appropriate wireless link. In other words, the network 512 encompasses any internal or external network, networks, sub-network, or combination thereof operable to facilitate communications between various computing components inside and outside the illustrated environment 500. The network 512 may communicate, for example, Internet Protocol (IP) packets, Frame Relay frames, Asynchronous Transfer Mode (ATM) cells, voice, video, data, and other suitable information between network addresses. The network 512 may also include one or more local area networks (LANs), radio access networks (RANs), metropolitan area networks (MANs), wide area networks (WANs), all or a portion of the Internet, and/or any other communication system or systems at one or more locations. The network 512, however, is not a required component of the present disclosure.

As illustrated in FIG. 8, server 502 includes a processor 518. Although illustrated as a single processor 518 in FIG. 8, two or more processors may be used according to particular needs, desires, or particular embodiments of environment 500. Each processor 518 may be a central processing unit (CPU), a blade, an application specific integrated circuit (ASIC), a field-programmable gate array (FPGA), or another suitable component. Generally, the processor 518 executes instructions and manipulates data to perform the operations of server 502 and, specifically, the one or more plurality of collaboration applications 522. Specifically, the server's processor 518 executes the functionality required to receive and respond to requests from the clients 535 and their respective client applications 544, as well as the functionality required to perform the other operations of the collaboration application 522.

Regardless of the particular implementation, “software” may include computer-readable instructions, firmware, wired or programmed hardware, or any combination thereof on a tangible medium operable when executed to perform at least the processes and operations described herein. Indeed, each software component may be fully or partially written or described in any appropriate computer language including C, C++, Java, Visual Basic, assembler, Peri, any suitable version of 4GL, as well as others. It will be understood that while portions of the software illustrated in FIG. 8 are shown as individual modules that implement the various features and functionality through various objects, methods, or other processes, the software may instead include a number of sub-modules, third party services, components, libraries, and such, as appropriate. Conversely, the features and functionality of various components can be combined into single components as appropriate. In the illustrated environment 500, processor 518 executes one or more collaboration applications 522 on the server 502.

At a high level, each of the one or more collaboration applications 522 is any application, program, module, process, or other software that may execute, change, delete, generate, or otherwise manage information according to the present disclosure, particularly in response to and in connection with one or more requests received from the illustrated clients 535 and their associated client applications 544. In certain cases, only one collaboration application 522 may be located at a particular server 502. In others, a plurality of related and/or unrelated collaboration applications 522 may be stored at a single server 502, or located across a plurality of other servers 502, as well. Additionally, the collaboration applications 522 may represent web-based applications accessed and executed by remote clients 535 or client applications 544 via the network 512 (e.g., through the Internet). Further, while illustrated as internal to server 502, one or more processes associated with a particular collaboration application 522 may be stored, referenced, or executed remotely. For example, a portion of a particular collaboration application 522 may be a web service associated with the application that is remotely called, while another portion of the collaboration application 522 may be an interface object or agent bundled for processing at a remote client 535 or 536. Moreover, any or all of the collaboration applications 522 may be a child or sub-module of another software module or enterprise application (not illustrated) without departing from the scope of this disclosure. Still further, portions of the collaboration application 522 may be executed by a user working directly at server 502, as well as remotely at client 535 or 536. As mentioned previously, server 502 may host collaboration applications 522 in a cloud based environment.

As illustrated, processor 518 can also execute a collaboration (via the collaboration application 522) that provides an environment and user interface for engaging in online collaborations involving at least one participant. The collaboration may also include other participants. In some implementations, the collaboration can be executed by a different processor or server external to server 502, such as by a server communicably coupled to server 502 through network 512. For example, the collaboration may be provided as an on-demand service through a cloud computing network, as a web service accessible via network 512, or as a service provided on a dedicated server. The collaboration can provide interfaces, modules, services, or metadata definitions that enable client applications 544 or 545 to provide support for implementing a business process executed at server 502 or at a different server or workstation. In the present disclosure, a business process may be any collection of related activities, tasks, or sequential steps performed in association with a particular business context, business partner, or customer. Business processes may be performed in software as a computer program and/or in connection with a computer microprocessor, server, workstation, instance of a computer program, thread of execution within a computer program, or other data processing element. Each business process may be associated with a workflow, and each distinct case or occurrence of the workflow or a portion of the workflow may be a separate process instance of a particular business process. Business processes are described in more detail below.

In the illustrated example, the server 502 may provide a collaboration application 522 for presenting graphical tools to clients for participating in collaborations and for interacting with gadgets or widgets associated with a business process. In general, the server 502 also includes memory 520 for storing data and program instructions. Memory 520 may include any memory or database module and may take the form of volatile or non-volatile memory including, without limitation, magnetic media, optical media, random access memory (RAM), read-only memory (ROM), removable media, or any other suitable local or remote memory component. Memory 520 may store various objects or data, including classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the server 502 and its one or more collaboration applications 522. In some implementations, collaboration application 522 is available to a client, such as client 535, through a web browser-based application at client 535. In some instances, collaboration application 522 persists in a cloud based network. Example collaboration applications include SAP Streamwork, Jam, Google Wave, TextFlow™, Google Groups, MindMeister, and Zoho™. The collaboration may be a synchronous collaboration, such as collaborations undertaken using a chat program or other synchronous collaboration tools. The collaboration may be asynchronous, and the participants may use e-mail programs to conduct the collaboration.

The illustrated environment of FIG. 8 also includes one or more clients 535. Each client 535 may be any computing device operable to connect to or communicate with at least the server 502 and/or via the network 512 using a wireline or wireless connection. In addition, client 535 may persist in a cloud based network. Further, as illustrated in FIG. 8, client 535 includes a processor 546, an interface 542, a graphical user interface (GUI) 560b, a client application 544, and a memory 550. In general, client 535 comprises an electronic computer device operable to receive, transmit, process, and store any appropriate data associated with the environment 500 of FIG. 8. It will be understood that there may be any number of clients 535 associated with, or external to, environment 500. For example, while illustrated environment 500 includes one client 535, alternative implementations of environment 500 may include multiple clients communicably coupled to the server 502, or any other number of clients suitable to the purposes of the environment 500. Additionally, there may also be one or more additional clients 535 external to the illustrated portion of environment 500 that are capable of interacting with the environment 500 via the network 512. Further, the terms “client,” “user,” and “participant” may be used interchangeably as appropriate without departing from the scope of this disclosure. Moreover, while each client 535 is described in terms of being used by a single user, this disclosure contemplates that many users may use one computer, or that one user may use multiple computers. Client application 544 may be a web browser or other application used to access, join, and/or participate in a collaboration on collaboration application 522 hosted on server 502.

The collaboration application facilitates decision making: it prompts one or more users for decisions, it receives decisions made by one or more users, it reports final decisions, it seeks approval of provisional decisions, its allows for decisions to be reopened as necessary, etc. FIG. 8 depicts a generalized example for a suitable computing system 1100 in which the described innovations may be implemented. The computing system 1100 is not intended to suggest any limitation as to scope of use or functionality, as the innovations may be implemented in diverse general-purpose or special-purpose computing systems.

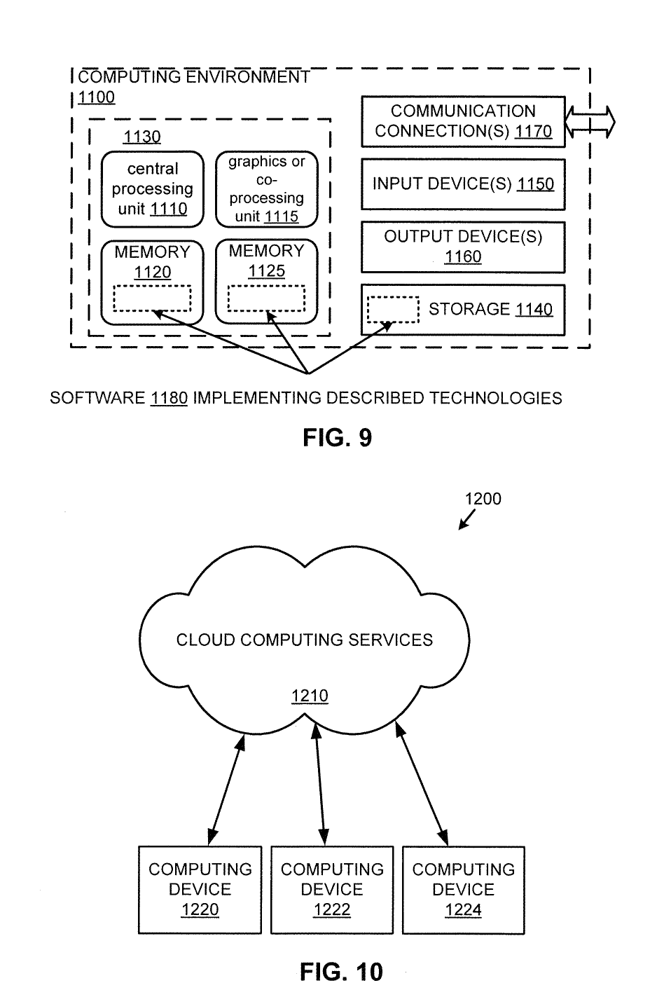

With reference to FIG. 9, the computing system 1100 includes one or more processing units 1110, 1115 and memory 1120, 1125. In FIG. 9, this basic configuration 1130 is included within a dashed line. The processing units 1110, 1115 execute computer-executable instructions. A processing unit can be a general-purpose central processing unit (CPU), processor in an application-specific integrated circuit (ASIC) or any other type of processor. In a multiprocessing system, multiple processing units execute computer-executable instructions to increase processing power. For example, FIG. 9 shows a central processing unit 1110 as well as a graphic processing unit or co-processing unit 1115. The tangible memory 1120, 1125 may be volatile memory (e.g., registers, cashes, RAM), non-volatile memory (e.g., ROM, EEPROM, flash memory), or some combination of the two, accessible by the processing unit(s). The memory 1120, 1125 stores software 1180 implementing one or more innovations described herein, in the form of computer-executable instructions suitable for execution by the processing unit(s).

A computing system may have additional features. For example, the computing system 1100 includes storage 1140, one or more input devices 1150, one or more output devices 1160, and one or more communication connections 1170. An interconnection mechanism (not shown) such as a bus, controller, or network interconnects the components of the computing system 1100. Typically, operating system software (not shown) provides an operating environment for other software executing in the computing system 1100 and coordinates activities of the components of the computing system 1100.

The tangible storage 1140 may be removable or non-removable, and incudes magnetic disks, magnetic tapes or cassettes, CD-ROMs, DVDs or any other medium which can be used to store information in a non-transitory way and which can be accessed within the computing system 1100. The storage 1140 stores instructions for the software 1180 implementing one or more innovations described herein. The input device(s) 1150 may be a touch input device such as a keyboard, mouse, pen or trackball, a voice input device, a scanning device, or another device that provides input to the computing system 1100. For video encoding, the input device(s) 1150 may be a camera, video card, TV tuner card, or other similar device that accepts video input in analog or digital form, or a CD-ROM or CD-RW that reads video samples into the computing system 1100. The output device(s) 1160 may be a display, printer, speaker, CD-writer, or another device that provides output from the computing system 1100.

The communication connection(s) 1170 enable communication over a communication medium to another computing entity. The communication medium conveys information such as computer-executable instructions, audio or video input or output, or other data in a modulated data signal. A modulated data signal is a signal that has one or more of its characteristics set or changed in such a matter as to encode information in the signal. By way of example, and not limitation, communication media can use an electrical, optical, RF or other carrier.

The innovations can be described in the general context of computer-executable instructions, such as those included in program modules, being executed in a computing system on a target reel or virtual processor. Generally, program modules include routines, programs, libraries, objects, classes, components, data structures, etc., that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can local or distributed, and can include any combination of special-purpose hardware and/or general-purpose hardware with software implementing the functionality described herein.

For the sake of presentation, the detailed description uses terms like “determine” and “use” to describe computer operations in a computing system. The terms are high-level abstractions for operations being performed by a computer, and should not be confused with acts performed by a human being. The actual computer operations corresponding to these terms very depending upon implementation.

FIG. 10 depicts an example cloud computing environment 1200 in which the described technologies can be implemented. The cloud computing environment 1200 comprises cloud computing services 1210. The cloud computing services 1210 can comprise various types of cloud computing resources, such as computer servers, data storage repositories, networking resources, etc. The cloud computing serves 1210 can be centrally located (e.g., provided by a data center of a business or organization) or distributed (e.g., provided by various computing resources located at different locations, such as different data centers and/or located in different cities or countries).

The cloud computing services 1210 are utilized by various types of computing devices (e.g., client computing devices), such as computing devices 1220, 1222 and 1224. For example, the computing devices can be computers (e.g., desktop or laptop computers), mobile devices (e.g., tablet computers or smart phones), or other types of computing devices. For example, the computing devices (e.g., 1220, 1222 and 1224) can utilize the cloud computing serves 1210 to perform computing operations (e.g., data processing, data storage and the like).

Although the operations of some of the disclosed methods are described in a particular, sequential order or convenient presentations, it should be understood that this manner of description encompasses rearrangement, unless a particular ordering is required by specific language set forth below. For example, operations described sequentially may in some cases may be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media and executed on a computing device (e.g., any available computing device, including smartphones or other mobile devices that include computing hardware). Computer readable storage media are any available tangible media that can be accessed within a computing environment (e.g., non-transitory computer-readable media, such as one or more optical media disks such as DVD or CD disks, volatile memory components (such as DRAM or SHRAM), or non-volatile memory components (such as flash memory or hard drives)). By way of example and with reference to FIG. 9, computer-readable storage media include memory 1120 and 1125 and storage 1140. As should be readily understood, the term “computer-readable storage media” does not include communication connections (e.g., 1170) such as modulated data signals.

Any of the computer-executable instructions for implementing the disclosed techniques as well as any data created and used in implementation of the disclosed embodiments can be stored on one or more computer-readable storage media (e.g., non-transitory computer-readable media). The computer-executable instructions can be part of, for example, a dedicated software application or a software application that is accessed or downloaded via web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For example, the disclosed technology can be implemented by software written in C++, Java, Perl, Java Script, HTML5, ABAP, Adobe Flash, or any other suitable programming language. The text analysis engine described herein can be implemented in SAP BusinessObjects Text Analysis or other suitable text processing tools.

Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or merely accessed through a suitable communication means. Such suitable communication means include, for example, the Internet, the Worldwide Web, an intranet software applications, cable (including fiber optic cable), magnetic communications, electromagnetic communications (including RF, microwave, and infrared communications), electronic communications, or other communication means.

The disclosed methods, apparatus and systems should not be construed in limiting in anyway. Instead, the present disclosure is directed toward all novel and nonobvious features and aspects of the various disclosed embodiments, alone in various combinations and sub combinations with one another. The disclosed methods, devices and systems are not limited to any specific aspect or feature or combination thereof, nor do the disclosed embodiments require that any one or more specific advantages be present or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the following claims. I therefore claim as my invention all that comes within the spirit and scope of the claims.

We claim:

1. A method, implemented at least in part by one or more computing devices, for analyzing a contract document to identify risks, the method comprising:
analyzing text of a contract document using a text analysis engine;
comparing text of the contract document to a clause dictionary; and
identifying at least one clause of the contract document to a user based on its risk level.

2. The method of claim 1, further comprising displaying the contract document to the user with the identified clause highlighted.

3. The method of claim 1, further comprising determining at least one alternative clause to the identified clause.

4. The method of claim 1, further comprising receiving input from the user, the input including a clause to be added to the clause dictionary.

5. The method of claim 1, further comprising receiving a spreadsheet input to update the clause dictionary.

6. The method of claim 1, further comprising updating the clause dictionary based on the results of a contract risk assessment survey.

7. The method of claim 1, further comprising determining at least one alternative clause to an identified high risk clause, displaying the alternative clause to the user, receiving an input from the user to select the alternative clause and updating the contract document by replacing the high risk clause by the selected alternative clause.

8. A contract document analysis system, comprising:
a user interface configured to display a contract document;
a clause dictionary stored in memory, the clause dictionary comprising predetermined clauses of interest to users;
an analysis engine that receives at least a portion of the contract document and performs text analysis to determine whether the contract document contains any qualifying clauses that resemble the predetermined clauses in the clause dictionary;
wherein for each qualifying clause, the user interface displays suggestions for action to the user.

9. The system of claim 8, wherein the predetermined clauses in the clause dictionary comprise clauses specified by users.

10. The system of claim 8, wherein the predetermined clauses in the clause dictionary comprise clauses determined at least in part by analytics.

11. The system of claim 8, wherein qualifying clauses that resemble the predetermined clauses comprise qualifying clauses that match the predetermined clauses.

12. The system of claim 8, wherein qualifying clauses that resemble the predetermined clauses comprise qualifying clauses that are close variants of the predetermined clauses.

13. The system of claim 8, wherein qualifying clauses that resemble the predetermined clauses comprise qualifying clauses that have predetermined expressions and patterns of the predetermined clauses.

14. The system of claim 8, wherein the user interface includes a separate portion adjacent the contract document within which the suggestions to the user are displayed.

15. The system of claim 8, wherein the suggestions for action comprise selecting a substitute clause to replace a qualifying clause.

16. The system of claim 8, wherein the analysis engine performs text analysis to extract a contract value from the contract document.

17. The system of claim 16, wherein the analysis engine searches for monetary terms in the contract document and assigns a contract value based on the monetary terms.

18. The system of claim 8, wherein the analysis engine produces a quadrant report based on contract value, contract risk and priority.

19. The system of claim 18, wherein the analysis engine receives a priority value entered by the user.

20. The system of claim 18, wherein the contract risk is determined based on aggregating a risk level for clauses of the contract document.
